(19) United States
(12) Patent Application Publication
(10) Pub. No.: US 2022/0276863 A1
(43) Pub. Date: Sep. 1, 2022

(54) SOFTWARE ANALYZING DEVICE, SOFTWARE ANALYZING METHOD, AND COMPUTER READABLE MEDIUM

(71) Applicant: NEC Corporation, Minato-ku, Tokyo (JP)

(72) Inventors: Yusuke SHIMADA, Tokyo (JP); Takayuki SASAKI, Tokyo (JP)

(73) Assignee: NEC Corporation, Minato-ku, Tokyo (JP)

(21) Appl. No.: 17/631,743

(22) PCT Filed: Aug. 8, 2019
(86) PCT No.: PCT/JP2019/031466

§ 371 Date: Jan. 31, 2022

(51) Int. Cl. G06F 8/75; G06F 8/72

(52) U.S. Cl. CPC G06F 8/75; G06F 8/72

(57) ABSTRACT

A software analyzing device capable of extracting a candidate for an unauthorized feature or an unnecessary feature contained in a code of software is to be provided. The software analyzing device includes a feature identifying means for identifying a predetermined specific feature in a code of software, a control-flow identifying means for identifying a control flow connecting with the specific feature, and a candidate extracting means for extracting, as a candidate for an unauthorized feature or an unnecessary feature, a first code part the code of the software unreachable from the control flow connecting with the specific feature.

### TECHNICAL FIELD

The present invention relates to a software analyzing device, a software analyzing method, and a computer readable medium.

### BACKGROUND ART

Techniques for identifying unauthorized factors in software have been developed. Patent Literature 1 discloses a technique for analyzing, in the opposite direction to the control flow of an application program, a propagation path of unauthorized operation, using a predetermined part that performs the unauthorized operation in the application program as an analyzing start point.

### CITATION LIST

### Patent Literature

Patent Literature 1: Japanese Unexamined Patent Application Publication No. 2011-253363

### SUMMARY OF INVENTION

### Technical Problem

In recent years, infrastructures and enterprise systems have been complicated. Thus, these infrastructures and enterprise systems are generally built by combining devices of various companies. There are many reports of the cases in which hidden features or unexpected features that users do not recognize are discovered in software (firmware) and hardware procured from outside manufacturers. For these reasons, manufacturers that manage the building infrastructures and enterprise systems need to inspect software procured from outside manufacturers for unauthorized features or unnecessary features such as backdoor. However, in order to extract candidates for unauthorized features or unnecessary features such as backdoor, it has been required to compare the code of the software with the specifications, which takes time and labor.

In view of the above problems, a purpose of the present disclosure is to provide a software analyzing device that solves any of the above problems.

### Solution to Problem

A software analyzing device according to a first aspect of the present invention includes a feature identifying means for identifying a predetermined specific feature in a code of software, a control-flow identifying means for identifying a control flow connecting with the specific feature, and a candidate extracting means for extracting, as a candidate for an unauthorized feature or an unnecessary feature, a first code part of the code of the software unreachable from the control flow connecting with the specific feature.

A software analyzing method according to a second aspect of the present invention include the steps of identifying a predetermined specific feature in a code of software, identifying a control flow connecting with the specific feature, and extracting, as a candidate for an unauthorized feature or an unnecessary feature, a first code part of the code of the software unreachable from the control flow connecting with the specific feature.

A non-transitory computer-readable medium according to a third aspect of the present invention stores a program causing a computer to execute the steps of identifying a predetermined specific feature in a code of software, identifying a control flow connecting with the specific feature, and extracting, as a candidate for an unauthorized feature or an unnecessary feature, a first code part of the code of the software unreachable from the control flow connecting with the specific feature.

### Advantageous Effects of Invention

According to the present invention, without comparing a code of software with the specifications, it is possible to extract a candidate for an unauthorized feature or an unnecessary feature contained in the code of the software.

### BRIEF DESCRIPTION OF DRAWINGS

FIG. 1 is a block diagram showing a configuration of a software analyzing device according to a first example embodiment;

FIG. 2 is a block diagram showing a configuration of a software analyzing device according to a second example embodiment;

FIG. 3 is a schematic diagram for explaining a first code part and a second code part;

FIG. 4 is a schematic diagram for explaining a first code part and a second code part;

FIG. 5 is a schematic diagram for explaining a first code part and a second code part;

FIG. 6 is a flowchart for explaining a procedure of processing in the software analyzing device according to the second example embodiment;

FIG. 7 is a flowchart showing the details of the processing in step S103 of FIG. 5;

FIG. 8 is a block diagram showing a configuration of a software analyzing device that identifies an unauthorized feature or an unnecessary feature contained in a code of software according to a first reference embodiment;

FIG. 9 is a flowchart for explaining a procedure of processing of identifying an unauthorized feature or an unnecessary feature contained in a code of software according to the first reference embodiment;

FIG. 10 is a block diagram showing a configuration of a software analyzing device that identifies an unauthorized feature or an unnecessary feature contained in a code of software according to the first reference embodiment; and

FIG. 11 is a flowchart for explaining a procedure of processing of identifying an unauthorized feature or an unnecessary feature contained in a code of software according to a second reference embodiment.

### DESCRIPTION OF EMBODIMENTS

Hereinafter, example embodiments of the present invention will be described with reference to the drawings. The following description and the drawings are appropriately omitted or simplified to clarify the explanation. In the drawings, the same elements are denoted by the same reference signs, and duplicated descriptions are omitted as necessary.

### First Example Embodiment

A first example embodiment will be described below.

FIG. 1 is a block diagram showing a configuration of a software analyzing device 10 according to a first example embodiment. As shown in FIG. 1, the software analyzing device 10 includes a feature identifying means 11, a control-flow identifying means 12, and a candidate extracting means 13.

The feature identifying means 11 identifies a predetermined specific feature in a code of software. The control-flow identifying means 12 identifies a control flow connecting with the specific feature. The candidate extracting means 13 extracts, as a candidate for an unauthorized feature or an unnecessary feature, a first code part of the code of the software unreachable from the control flow connecting with the specific feature.

Accordingly, without comparing a code of software with the specifications, it is possible to extract a candidate for an unauthorized feature or an unnecessary feature contained in the code of the software.

### Second Example Embodiment

A second example embodiment will be described below.

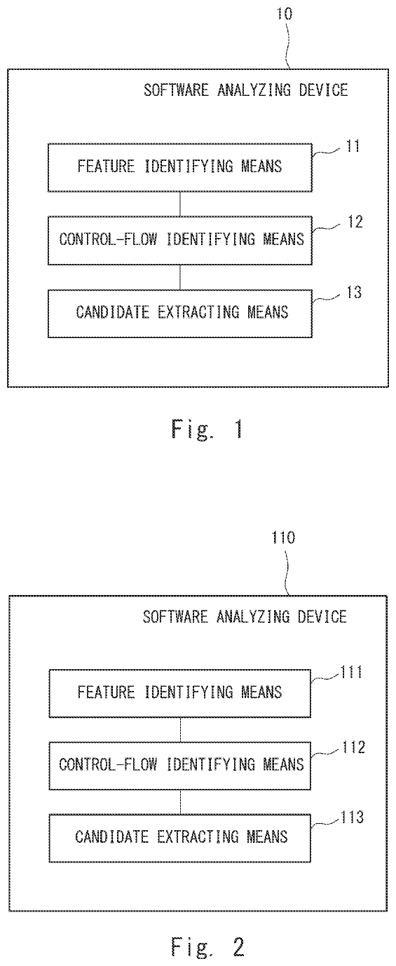

First, a configuration example of a software analyzing device according to the second example embodiment is described. FIG. 2 is a block diagram showing a configuration of a software analyzing device 110 according to the second example embodiment. As shown in FIG. 2, the software analyzing device 110 includes a feature identifying means 111, a control-flow identifying means 112, and a candidate extracting means 113.

The feature identifying means 111 identifies a predetermined specific feature in a code of software. Here, the specific feature is a feature that is always passed through when a normal feature in the software is executed, such as an authentication feature, a parser feature, an input interface, a main function (also referred to as an entry function to the program) or pre-processing of a main function. Note that, a method of identifying a specific feature in a code of software, may be an existing method of, for example, searching for a characteristic function used in the specific feature. The control-flow identifying means 112 identifies a control flow connecting with the specific feature. The candidate extracting means 113 extracts, as a candidate for an unauthorized feature or an unnecessary feature, a first code part of the code of the software unreachable from the control flow connecting with the specific feature.

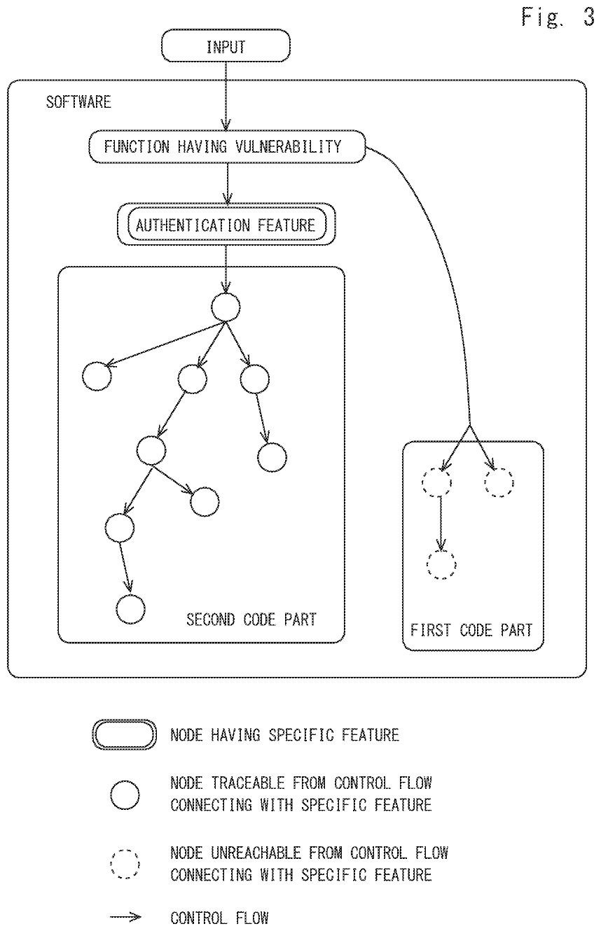

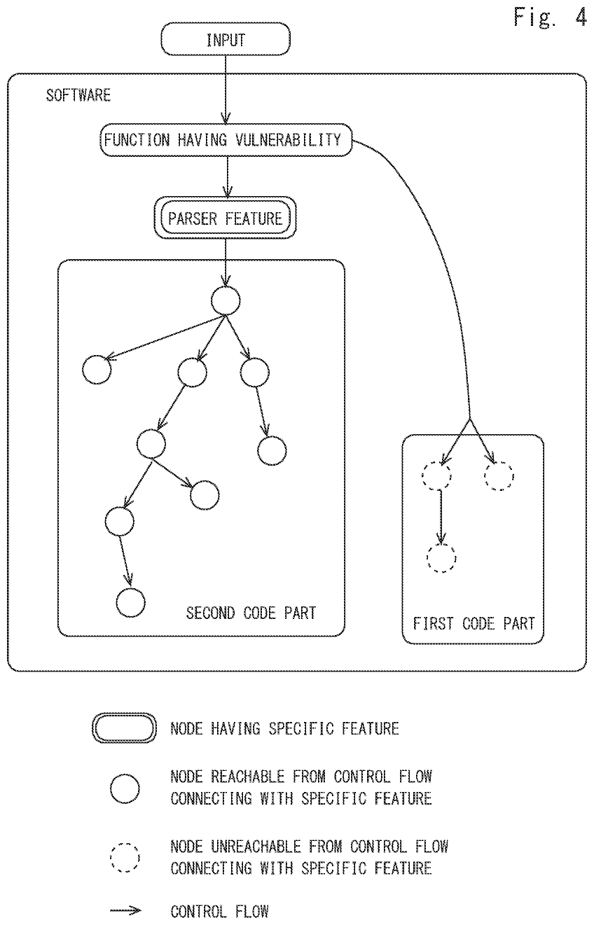

FIGS. 3 to 5 are schematic diagrams for explaining first code parts and second code parts.

FIG. 3 shows a case in which the specific feature is an authentication feature. Of the code of the software, a code part corresponding to nodes and control flows reachable from the control flow connecting with the authentication feature is a second code part. Meanwhile, of the code of the software, a code part corresponding to nodes and control flows unreachable from the control flow connecting with the authentication feature is a first code part. The authentication feature confirms the access authority of a user who accesses the software and is always passed through when each feature in the software is called. That is, the part of the code of the software unreachable from the control flow connecting with the authentication feature is a code to be called without authentication and is highly possible to be an unauthorized feature.

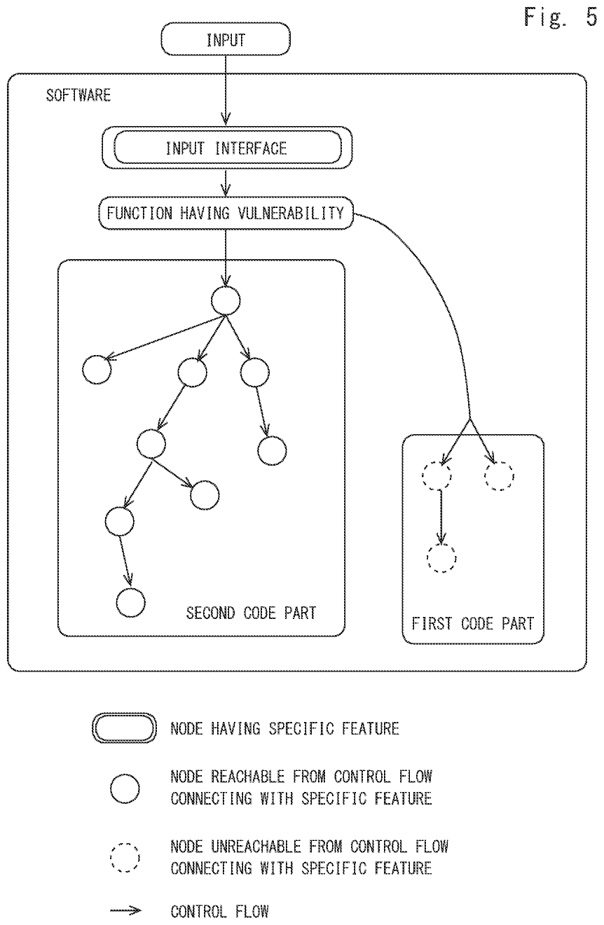

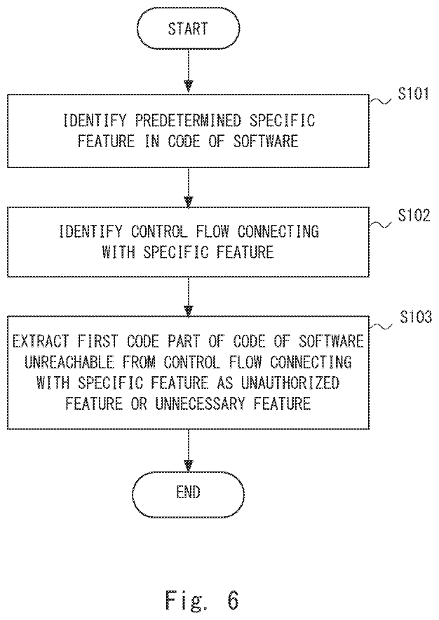

FIG. 4 shows a case in which the specific feature is a parser feature. Of the code of the software, a code part corresponding to nodes and control flows reachable from the control flow connecting with the parser feature is a second code part. Meanwhile, of the code of the software, a code part corresponding to nodes and control flows unreachable from the control flow connecting with the parser feature is a first code part. The parser feature parses user input and executes a relevant command. Each feature of the software is always executed by a command from the parser feature. That is, the part of the code of the software unreachable from the control flow connecting with the parser feature is not a feature to be used by a normal user and is highly possible to be an unauthorized feature.

FIG. 5 shows a case in which the specific feature is an input interface. The input interface is, for example, a function for accepting user input or a function for receiving network packets. Normally, a parser feature is below the input interface, but if the parser feature is difficult to find, the input interface may be the specific feature. Of the code of the software, a code part corresponding to nodes and control flows reachable from the control flow connecting with the input interface is a second code part. Meanwhile, of the code of the software, a code part corresponding to nodes and control flows unreachable from the control flow connecting with the input interface is a first code part. If the input interface has vulnerability or if the subsequent functions have vulnerability, malicious user input can lead to a feature unreachable from the input interface, and such a feature is highly possible to be an unauthorized feature.

The specific feature may be a feature other than the above features. For example, software usually has a configuration in which there is a main function and functions of various features are called from the main function. Thus, the main function may be set as the specific feature, and control flows connecting therefrom may be traced. In addition, a feature for preparing to execute a program to be executed before the main function may be identified as the specific feature, control flows therefrom may be traced.

Next, a procedure of processing in the software analyzing device 110 will be described. Note that, FIG. 2 is appropriately referred to in the following description.

FIG. 5 is a flowchart for explaining a procedure of processing in the software analyzing device 110. As shown in FIG. 5, first, the feature identifying means 111 identifies a predetermined specific feature in a code of software (step S101). Then, the control-flow identifying means 112 identifies a control flow connecting with the specific feature (step S102). Then, the candidate extracting means 113 extracts, as a candidate for an unauthorized feature or an unnecessary feature, a first code part of the code of the software unreachable from the control flow connecting with the specific feature (step S103).

Next, the details of the processing in step S103 of FIG. 5 are described.

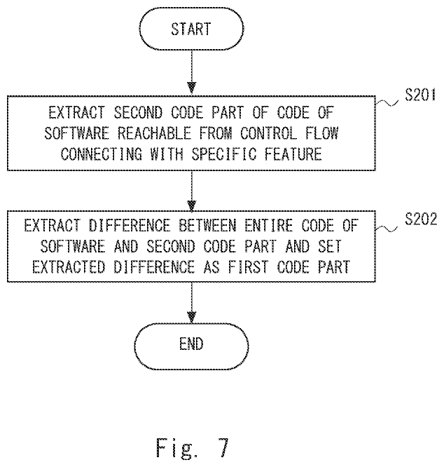

FIG. 7 is a flowchart showing the details of the processing in step S103 of FIG. 5. As shown in FIG. 7, first, a second code part of the code of the software reachable from the control flow connecting with the specific feature is extracted (step S201). Then, the difference between the entire code of the software and the second code part is extracted, and the extracted difference is set as a first code part (step S202).

From the above, the software analyzing device 110 extracts, as a candidate for an unauthorized feature or an unnecessary feature, a first code part of a code of software unreachable from the control flow connecting with a specific feature that is always passed through when a normal feature is executed. Accordingly, it is possible to extract a candidate for an unauthorized feature or an unnecessary feature contained in a code of software without comparing the code of the software with the specifications.

### First Reference Embodiment

As a method of extracting a candidate for an unauthorized feature or an unnecessary feature contained in a code of software, a reference embodiment described below is conceivable. This method is based on the assumption that by trying all the test cases procured from the manufacturer of the software, operation of all the normal features of the software can be checked.

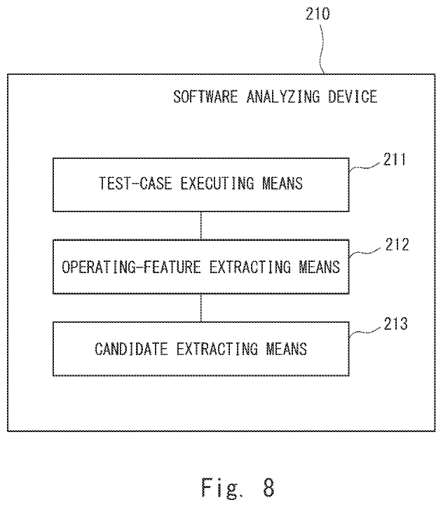

FIG. 8 is a block diagram showing a configuration of a software analyzing device 210 that identifies an unauthorized feature or an unnecessary feature contained in a code of software according to a first reference embodiment. As shown in FIG. 8, the software analyzing device 210 includes a test-case executing means 211, an operating-feature extracting means 212, and a candidate extracting means 213.

The test-case executing means 211 executes a test case procured from the software developer to check normal features and records the operation. The operating-feature extracting means 212 extracts, from the code of the software, features that operate when the test case is executed. The candidate extracting means 213 compares the code of all the extracted features with the code of the software and extracts the difference between the code of all the extracted features and the code of the software as a candidate for an unauthorized feature or an unnecessary feature.

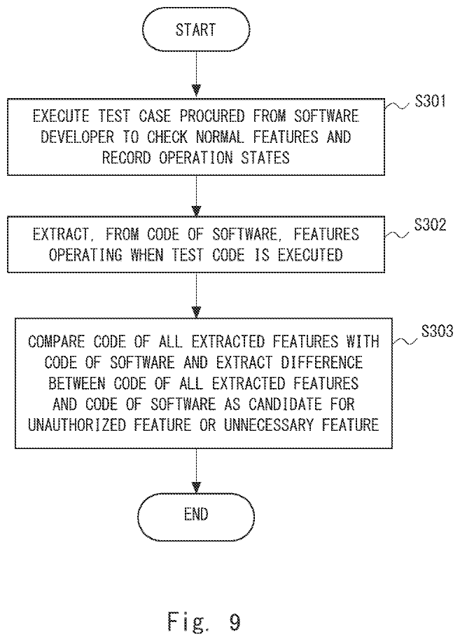

FIG. 9 is a flowchart for explaining a procedure of processing of identifying an unauthorized feature or an unnecessary feature contained in a code of software according to the first reference embodiment. As shown in FIG. 9, first, the test-case executing means 211 executes a test case procured from the software developer to check normal features and records operating states (step S301). Then, the operating-feature extracting means 212 extracts, from the code of the software, features that operate when the test case is executed (step S302). Then, the candidate extracting means 213 compares the code of all the extracted features with the code of the software and extracts the difference between the code of all the extracted features and the code of the software as a candidate for an unauthorized feature or an unnecessary feature (step S303).

### Second Reference Embodiment

As a method of extracting a candidate for an unauthorized feature or an unnecessary feature contained in a code of software, a reference embodiment described below is conceivable. This method is based on the assumption that if the software is executed for a certain period of time, all the normal features of the software or normal features frequently used by a user are executed.

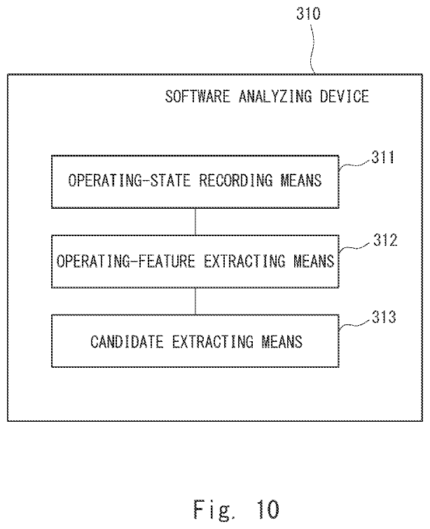

FIG. 10 is a block diagram showing a configuration of a software analyzing device 310 that identifies an unauthorized feature or an unnecessary feature contained in a code of software according to a second reference embodiment. As shown in FIG. 10, the software analyzing device 310 includes an operating-state recording means 311, an operating-feature extracting means 312, and a candidate extracting means 313.

The operating-state recording means 311 records the operating state of the software for a predetermined period of time. The operating-feature extracting means 312 extracts, from the code of the software, features having operated during the predetermined period of time. The candidate extracting means 313 compares the code of all the extracted features with the code of the software and extracts the difference between the code of all the extracted features with the code of the software as a candidate for an unauthorized feature or an unnecessary feature.

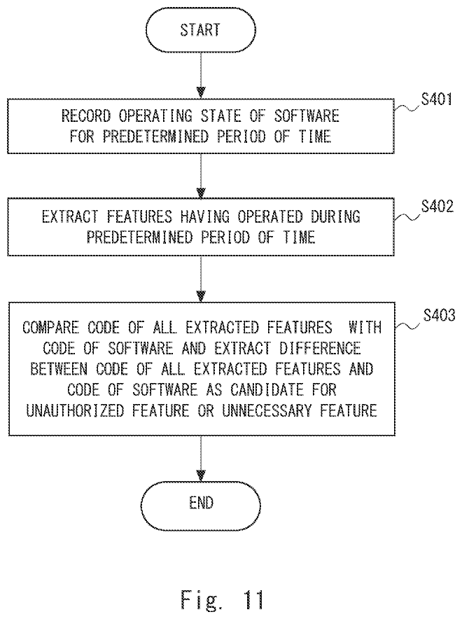

FIG. 11 is a flowchart for explaining a procedure of processing of identifying an unauthorized feature or an unnecessary feature contained in a code of software according to the second reference embodiment. As shown in FIG. 11, first, the operating-state recording means 311 records the operating state of the software for a predetermined period of time (step S401). Then, the operating-feature extracting means 312 extracts, from the code of the software, features having operated during the predetermined period of time (step S402). Then, the candidate extracting means 313 compares the code of all the extracted features with the code of the software and extracts the difference between the code of all the extracted features and the code of the software as a candidate for an unauthorized feature or an unnecessary feature (step S403).

In the above example embodiments, the present invention is described as a hardware configuration, but the present invention is not limited thereto. The present invention can be achieved by a central processing unit (CPU) executing a program.

The program for performing the above processing can be stored by various types of non-transitory computer-readable media and provided to a computer. Non-transitory computer readable media include any type of tangible storage media. Examples of non-transitory computer readable media include magnetic storage media (such as flexible disks, magnetic tapes, hard disk drives, etc.), optical magnetic storage media (such as magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, and Random Access Memory (RAM)). The program may be provided to a computer using any type of transitory computer readable media. Examples of transitory computer readable media include electric signals, optical signals, and electromagnetic waves. Transitory computer readable media can provide the program to a computer via a wired communication line (such as electric wires, and optical fibers) or a wireless communication line.

The present invention has been described above with reference to the example embodiments but is not limited by the above. Various modifications that can be understood by those skilled in the art can be made to the configurations and the details of the present invention without departing from the scope of the invention.

### REFERENCE SIGNS LIST

10, 110 Software analyzing device
11, 111 Feature identifying means
12, 112 Control-flow identifying means
13, 113 Candidate extracting means

What is claimed is:

1. A software analyzing device comprising:
hardware, including at least one processor and memory;
a feature identifying unit, implemented by the hardware, configured to identify a predetermined specific feature in a code of software;
a control-flow identifying unit, implemented by the hardware, configured to identify a control flow connecting with the specific feature; and
a candidate extracting unit, implemented by the hardware, configured to extract, as a candidate for an unauthorized feature or an unnecessary feature, a first code part of the code of the software unreachable from the control flow connecting with the specific feature.

2. The software analyzing device according to claim 1, wherein the specific feature is any one of an authentication feature, a parser feature for parsing user input and executing a relevant command, an input interface, a main function, or pre-processing of a main function.

3. The software analyzing device according to claim 1, wherein the first code part is a difference between an entire code of the software and a second code part of the code of the software reachable from the control flow connecting with the specific feature.

4. A software analyzing method comprising the steps of:
identifying a predetermined specific feature in a code of software;
identifying a control flow connecting with the specific feature; and
extracting, as a candidate for an unauthorized feature or an unnecessary feature, a first code part of the code of the software unreachable from the control flow connecting with the specific feature.

5. A non-transitory computer-readable medium storing a program causing a computer to execute the steps of:
identifying a predetermined specific feature in a code of software;
identifying a control flow connecting with the specific feature; and
extracting, as a candidate for an unauthorized feature or an unnecessary feature, a first code part of the code of the software unreachable from the control flow connecting with the specific feature.
